(19) United States
(12) Patent Application Publication
(10) Pub. No.: US 2002/0104103 A1
(43) Pub. Date: Aug. 1, 2002

(54) Channel selection device for digital/analog broadcasting receiver

(75) Inventors: Toshihiro Takagi, Osaka (JP); Yusuke Nishida, Ikoma-shi (JP); Kazuhide Ishihara, Osaka (JP)

Correspondence Address: Crowell & Moring, L.L.P., P.O. Box 14300, Washington, DC, 20044-4300, US

(73) Assignee: Funai Electric Co., Ltd.

(21) Appl. No.: 10/058,036

(22) Filed: Jan. 29, 2002

(30) Foreign Application Priority Data
Jan. 31, 2001 (JP) 2001-24506

(51) Int. Cl. H04N 7/16; H04N 7/173

(52) U.S. Cl. 725/151; 725/100; 725/131; 725/139

(57) ABSTRACT

In a channel selection device in the digital/analog broadcasting receiver, when an instruction of the main/sub-channel change is given by ten keys, inputting by “-” key causes the main channel being currently received to be fixed, and a display device to OSD display a state of waiting for the sub-channel. This allows the hierarchical structure of the channel to be understood intuitively, and the input steps of the main channel to be simplified, thereby allowing the channel selection to be efficiently performed.

### BACKGROUND OF THE INVENTION

The present invention relates to a channel selection device in a broadcasting receiver for receiving the digital/analog broadcasts.

Conventionally, an input of an instruction of the channel selection in broadcasting receivers such as television receivers is made by an use of channel up/down keys provided in an input device such as a remote controller, or by a use of numerical-value input keys such as ten keys. It is advantageous for user to use the channel up/down keys to select a channel when he selects sequentially channels to see and hear a channel broadcasting a program he desires without deciding which channel is to be seen and heard. On the other hand, it is suitable for user to use the ten keys when he finds previously a channel he wants to see and hear, and he wants to quickly select the channel.

Meanwhile, in America, cable television has been widely popularized, whereby multi-channel has been realized, and recently the channel number increases to three digits. Hence, when inputting one-digit or two-digit channel number conventionally broadcasted, user must input all digits by giving “0” to the head of the number to distinguish the input from a state on the way to input a three-digit channel number, whereby a complex operation has been imposed to the user. Thus, in such cable-television receivers, in order to make easy the input of channel number at channel selecting, channel selection devices with various ideas have been proposed. For example, there is a device which is provided with an “Enter” key showing the completion of the channel number input, and the user, when selecting a channel to which two or less-digit number is given, inputs the “Enter” key following the above-mentioned number, whereby the device is made to recognize that the channel number is of two-digit, thereby simplifying the numerical-value input. There is also a device by which the user usually inputs two-digit number, and when inputting three-digit number, uses keys separately provided for inputting third-digit number, whereby the input of the two-digit number can be distinguished from that of the three-digit number to recognize. Also, for example, there is known a channel selection device by which, the user, when inputting “1” to the third digit of three-digit number, continues to press a “1” key for a predetermined time, whereby the device is made to recognize that the inputted numerical value is of three-digit (for example, see Japanese Unexamined Patent Publication No. 4-227379).

Conventionally the television is generally broadcasted by the analog broadcasting, in recent years, in addition to conventional analog broadcasting, there have been transmitted and rapidly popularized the digital broadcasting represented by the BS (Broadcasting Satellite) digital broadcasting and the CS (Communications Satellite) digital broadcasting, by which high-quality image and multi-channel are made possible. For example, the digital broadcasting in North America is standardized by ATSC (Advanced Television Systems Committee) of North America, and transmitted by a physical channel different from the analog broadcasting. There are many digital broadcastings transmitted from the same broadcasting station as that for the analog broadcasting or a broadcasting station with the same system as for the analog broadcasting. In this case, in order to improve the convenience for user who is accustomed to the channel number of the conventional analog broadcasting, the digital broadcasting has been operated such that channel selection and display can be performed by a virtual channel to which the same channel number as that for conventional analog broadcasting has been assigned.

In the digital broadcasting, there have been assigned to each channel a carrier wave having a predetermined frequency band different from that for the analog broadcasting. The channel is called a main channel, and one main channel includes a sub-channel to transmit one or a plurality of contents. In the above-mentioned ATSC standard, given as channel numbers to the channel are three-digit main channel number and two-digit channel number, and the channel is operated in a form shown with “main channel number-(hyphen)sub-channel number.”

The configuration of the sub-channel varies according to the broadcasting time band, and by way of example, FIG. 6 shows the configuration of the sub-channel in a time band (8:00 p.m. to 12:00 p.m.) of the main channel “4.” According to FIG. 6, at 8:00 p.m. to 9:00 p.m., the sub-channels “0” to “4” are broadcasted; at 9:00 p.m. to 10:00 p.m., the sub-channels “0” and “1”; at 10:00 p.m. to 11:00 p.m., the sub-channels “0” to “4”; and at 11:00 p.m. to 12:00 p.m., the sub-channels “0” to “3”. Here, the channels with the sub-channel “0” are of an analog broadcasting according to NTSC (National Television Systems Committee) standard, while the channels with the sub-channels “1” to “4” (the virtual channels “4-1” to “4-4”) are of a digital broadcasting. The television programs broadcasted from the channel “4-0” are those of the conventional analog broadcasting; the SD (Standard Definition) programs broadcasted from the virtual channels “4-1” to “4-4” are those with standard image quality of the digital broadcasting; the HD (High Definition) programs broadcasted from the virtual channel “4-1” are those with high image quality of the digital broadcasting.

In the digital broadcasting, the information (hereinafter described as the channel information) on the channel configuration fluctuating as described above is transmitted together with the signals of image and the like. Therefore, in the digital broadcast receiving system, receiving the above-mentioned digital signals by the tuner, decoding them by the digital decoder, and analyzing the VCT (Virtual Channel Table) included in the decoded signals allows the channel information of the broadcasting to be obtained.

In the digital broadcasting, the channel number is represented by “main channel-sub-channel,” so that when selecting a channel by using ten keys, a three-digit main channel and a two-digit sub-channel channel must be inputted. For example, the selection of a main channel “8” is performed by inputting “0” as shown in FIG. 7(a), inputting “0” as shown in FIG. 7(b), and inputting “8” as shown in FIG. 7(c). In this way, when inputting a main channel with a fewer number of digits, all digits having the head to which “0” is added must be inputted. When the three-digit main channel has been inputted, “-” following the number is automatically displayed, and sequentially the user is to input a two-digit sub-channel. Therefore, the user inputs continuously a five-digit number, and at this time, the main channel number and the sub-channel number are apt to cause a confusion therebetween. Thus, as described above, there has existed a conventional device with ideas to simplify the input of the channel number to be selected.

However, for a conventional device for inputting the number by the use of the “Enter” key, the user inputs a three-digit main channel number, then inputs the “Enter” key, and further inputs a two-digit sub-channel number, then the “Enter” key, thereby allowing the channel to be selected. However, the operation of inputting the “Enter” key between input operations of the main channel number and the sub-channel number which are originally separated with “-” (hyphen) from each other is instinctively hard to become accustomed, and thus required to be accustomed to operate. Also, the user, when wanting to change the sub-channel by inputting only the sub-channel number with the ten keys during receiving of image of any channel, must perform the same input operation as described above, so that a complex operation is imposed to the user.

When using keys for inputting three-digit number, or continuing to press a key for a predetermined time, it becomes easy for the user to input the three-digit main channel number, while with respect to the input a sub-channel, there is no particular idea, so that even when utilizing the “Enter” key for the input, there is a similar problem as described above.

### SUMMARY OF THE INVENTION

The present invention is made to solve the above-mentioned problems and it is an object of the invention to provide a channel selection device in a digital broadcast receiving system by which the user can perform the channel selection efficiently with a simple input operation having a fewer input steps, while understanding intuitively a complex channel configuration configured hierarchically by main/sub-channel.

In accordance with an aspect of the present invention, the broadcasting signals in the digital broadcasting include a sub-channel to transmit one or a plurality of contents for each main channel. The digital broadcasting having such channel configuration is in conformity to the ATSC standard, and according to the ATSC standard, the broadcasting is operated such that a three-digit channel number is given to the main channel, and a two-digit channel number to the sub-channel so as to display the channel number in a form in which “-” is inserted between respective channel numbers.

A first channel-selecting procedure processed by a control unit is executed when received an instruction from a predetermined operation key without receiving an input from a numerical-value key during the reception of a broadcasting by a receiver. According to the first channel-selecting procedure, a main channel is fixed as the one whose sub-channel number only is inputted from the numerical-value key without changing the selected main channel from the one in the broadcasting being received. Therefore, it is sufficient for the user to input only a desired sub-channel number following a predetermined key operation, whereby the user can easily select the channel.

A second channel-selecting procedure processed by a control unit is executed when received an input from a numerical-value key during the reception of a broadcasting by a receiver and further received an instruction from a predetermined operation key. According to the second channel-selecting procedure, a main channel is fixed by the number inputted before receiving an instruction from a predetermined operation key. Thereafter, a state of waiting for the input of sub-channel number is exhibited, and the main channel number is fixed as the one whose sub-channel number is inputted by the numerical-value key. Therefore, for example, when inputting a one-digit main channel number, inputting a predetermined operation key following the number allows a state to be shifted to the state of waiting for the input of sub-channel without inputting all digit numbers, thereby simplifying the input step required for channel selection. The above-mentioned operation causes the main channel number and the sub-channel number to be individually inputted by being separated from each other, thereby preventing a confusion between the main channel number and the sub-channel number.

In accordance with another feature of the invention, inputting of a predetermined operation key allows a state to be shifted to the state of waiting for the input of sub-channel, thereby omitting the input step of the main channel. A main channel number fixed at this time may be the one of the broadcasting being received, or may be the one specified previously by the user. It may also be the one which is highest frequent main channel among a past audition history stored in a memory.

In accordance with a further feature of the invention, a main channel to be selected is fixed as the one whose sub-channel number only is inputted from the numerical-value key without changing the selected main channel from the one in the broadcasting being received. Therefore, it is sufficient for the user to input only a desired sub-channel number following a predetermined key operation, whereby the user can easily select the channel.

In accordance with a further feature of the invention, the “-” key to which an operation to fix the main channel is assigned has the same form as the “-” inserted between the main channel number and the sub-channel number in the above-mentioned ATSC standard, so that the user can intuitively understand a relationship between the main channel and the sub-channel which are configured hierarchically, thereby making it easy to distinguish the main channel number from the sub-channel number.

In accordance with a further feature of the invention, the main/sub-channel number inputted or fixed is OSD displayed, so that the user can select the channel while watching a display. Particularly in the digital broadcasting with the ATSC standard, the relationship between the main channel and the sub-channel can be easily understood visually from the display, and at this time, by operating operation keys to which the same display as the character information obtained from an OSD display has been given, channel selection can be performed.

### BRIEF DESCRIPTION OF THE DRAWINGS

FIG. 1 is a block diagram of a broadcasting receiver according to one embodiment of the present invention.

FIG. 2 is a plan view of a remote controller used for a channel selection device of the receiver.

FIG. 3 is a view showing the operation of changing a channel by using ten keys of the device and a display.

FIG. 4 is a view showing the operation of changing another channel by using ten keys of the device and a display.

FIG. 5 is a flowchart when a channel is changed by a control unit of the device.

FIG. 6 is a view showing a channel configuration of the digital broadcasting received by the receiver.

FIG. 7 is a view showing the operation of changing a channel by using ten keys of a conventional channel selection device and a display.

### DETAILED DESCRIPTION OF THE PREFERRED EMBODIMENT OF THE PRESENT INVENTION

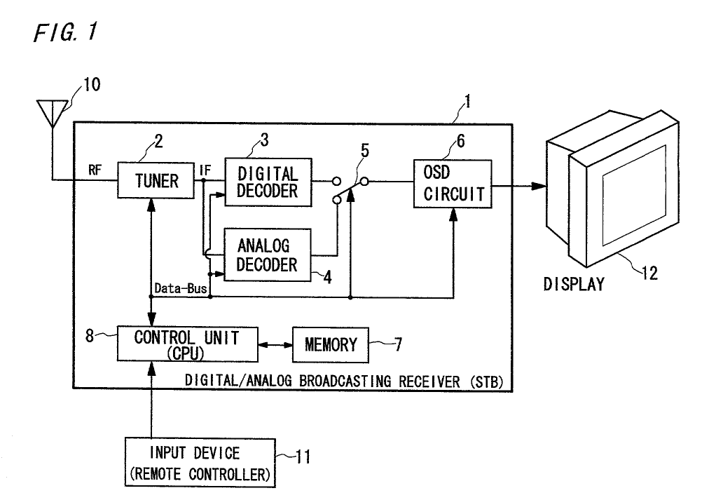

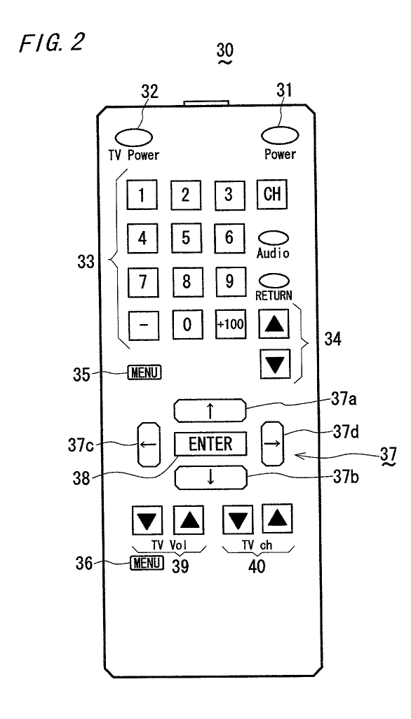

With reference to the drawings, a digital/analog broadcast receiving system in connection with an embodiment embodying the present invention will be explained hereinafter. FIG. 1 shows a block diagram of a digital/analog broadcast receiving system (hereinafter called the receiver). The receiver 1 is a set top box (STB) which receives coded digital/analog broadcasting signals with high-frequency (RF) transmitted from a television broadcasting station through an antenna 10, and in response to the operation input of the channel information display from the user using an input device 11 such as a body button or a remote controller 30 shown in FIG. 2 later described, displays in a list the channel information receivable to a display device 12 for On-Screen Displaying the image signals included in the broadcasting signals.

The receiver 1 includes a tuner 2 for receiving digital/analog broadcasting signals present in a frequency band corresponding to a desired channel, a digital decoder 3 and an analog decoder 4 for decoding the digital/analog broadcasting signals received by the tuner 2, a switch 5 for switching the broadcasting signals decoded by the digital decoder 3 or the analog decoder 4, an On-Screen Display (hereinafter described as OSD) circuit 6 for making the display device 12 to display a predetermined OSD, a memory 7 for storing the transmitted frequency of each main channel or the channel configuration information in the digital broadcasting, and a control unit 8 consisting of CPU for controlling each members of the receiver.

The tuner 2 receives the supply of the digital/analog broadcasting signals received by the antenna 10, performs the station selecting operation in response to an instruction inputted into the control unit 8 from the input device 11, receives the digital/analog broadcasting signals present in a frequency band corresponding to a channel inputted, and modulates them to intermediate frequency (IF) to output to the digital decoder 3 and the analog decoder 4. The digital decoder 3 and the analog decoder 4 decode the broadcasting signals received by the tuner 2. The channel configuration in the digital broadcasting is such that a frequency band different for each main channel is given, so that for a sub-channel in the same main channel, the broadcasting signals with the same frequency are transmitted. Even for the digital broadcasting having a virtual channel with the same number prefix as that for the analog broadcasting, the physical channels are different from each other, so that the broadcasting signals are transmitted by a carrier wave of a different frequency band. When a channel selected by the user is a digital broadcasting channel (when the sub-channel is not “0”), the decoding processing is executed by the digital decoder 3. When a channel selected by the user is an analog broadcasting channel (when the sub-channel is “0”), the decoding processing is executed by the analog decoder 4.

The switch 5 receives an instruction from the control unit 8, and outputs the broadcasting signals decoded by either the digital decoder 3 or the analog decoder 4 to the OSD circuit 6. The OSD circuit 6 outputs the broadcasting signals to the display device 12 according to the instruction from the control unit 8, and outputs OSD display signals to display a predetermined list in respect to the receivable channel information. The memory 7 stores the information on the frequency band of each channel or the channel configuration information, and stores the information on the OSD display at the time of the factory-shipped receiver.

The control unit 8 receives an input operation by the user using the input device 11 to execute various controls through the data bus, makes the memory 7 to store the information on the frequency band of each channel or the channel information received, and as required, refers to these information at the time of channel selecting and the like.

In response to an operation instruction made during the reception of the broadcasting by the receiver 1, the control unit 8 fixes a main/sub-channel, and changes to the fixed main/sub-channel. The change of channel is made according to the following procedure. That is, the control unit 8 makes the tuner 2 to receive the broadcasting signals of an applicable channel, analyzes VCT as the channel information obtained by decoding the broadcasting signals by the use of the digital decoder 3, and obtains status signals contained therein. The status signals usually include all digital/analog sub-channel information in a virtual main channel. Therefore, selecting one sub-channel allows the channel information on all sub-channels in the main channel to be obtained. The control unit 8 makes the memory 7 to store the obtained status signals, thereby making the memory 7 to store the channel information. Based on the channel information having been made stored in the memory, the control unit 8 extracts the broadcasting signals of the sub-channel fixed as described above out of the signals decoded by the digital decoder, and outputs an image after being selected to a display device.

Further, the control unit 8 decides whether a broadcasting signal is present based on the status signal, and makes the display device 12 to image output a predetermined OSD display or an image program of the broadcasting selected. The display device 12 may employ the display of a television receiver, and may be a flat panel display device such as LCD (Liquid Crystal Display) and PDP (Plasma Display Panel), as well as CRT. The receiver 1 includes a D/A converting circuit for converting digital signals to analog ones, though not shown, and the signals for the above-mentioned OSD display and image display are converted to analog signals by the D/A converting circuit, and then outputted to the display device 12. The above-mentioned D/A converting circuit may be configured to be contained in the display device 12. The digital signals, when displayed on the above-mentioned flat panel display, are outputted, as are kept unconverted, not through the D/A converting circuit.

The input device 11 is a device for inputting an operation instruction by the user into the control unit 8. An example of the input device 11 is a body button provided in front of the receiver 1 or a remote controller 30 as shown in FIG. 2. The remote controller 30 is configured such that it can indicate the operation of the receiver 1 and the television receiver by the use of infrared rays and the like. That is, the controller includes power keys 31, 32 for turning on/off the power source of the receiver 1 and the television receiver, ten keys (numerical-value input keys) 33 for inputting channel number of the receiver 1, channel up/down keys 34 used for changing the channel, menu keys 35, 36 for calling the menu display of the receiver 1 and the television receiver, direction keys 37 (37a through 37d) for shifting the cursor in a desired direction, an enter (ENTER) key 38 for fixing an input, volume up/down keys 39 for adjusting the voice volume of the television receiver, and channel up/down keys 40 used for changing the channels of the television receiver. Further, the ten keys are provided with, in addition to the numeric keys for inputting numeric characters, a “-” key (operation key) 33a to which an operation instruction for fixing a channel has been assigned.

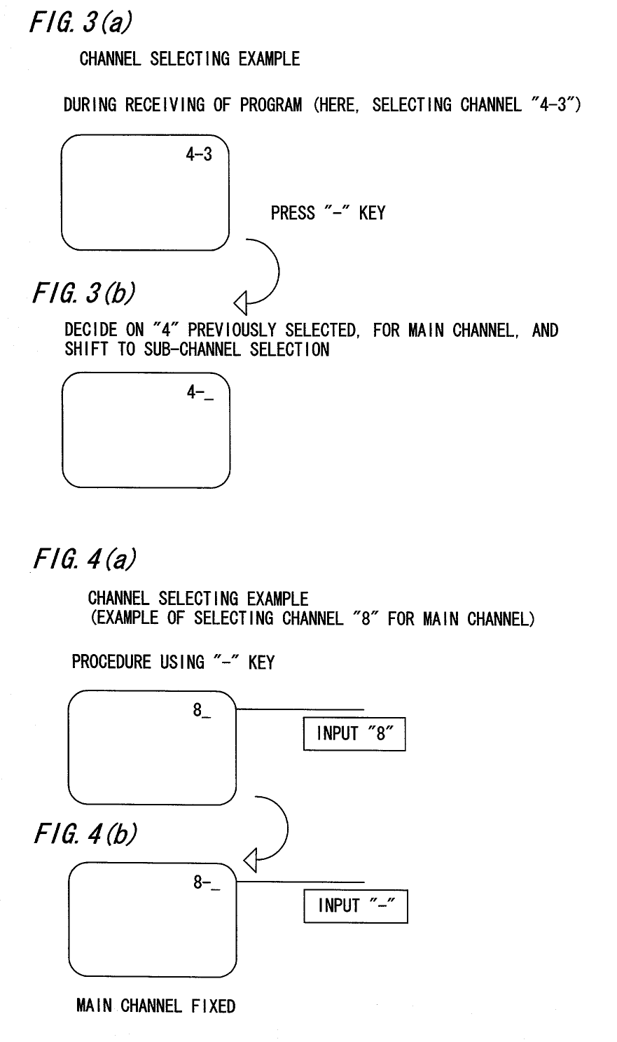

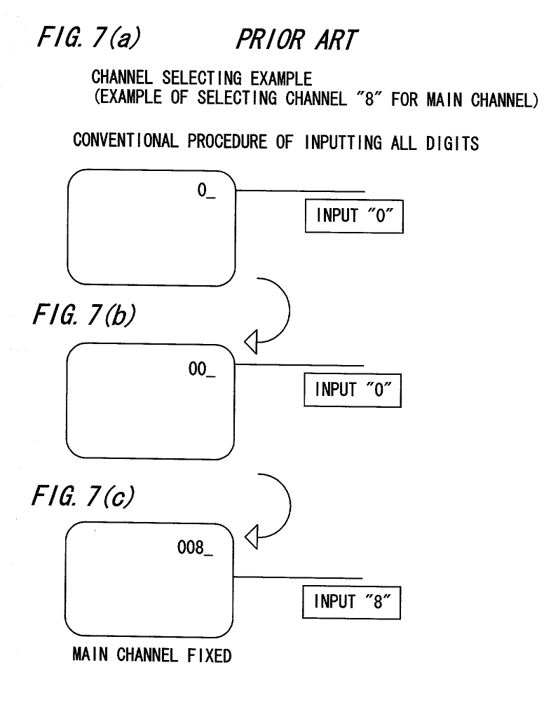

Giving an example in FIG. 3, the operation of channel change using the ten keys of the remote controller 30 will be explained hereinafter. The example shows a case where during period when the broadcasting signals (program) of a channel “4-3” is received as shown in FIG. 3(a), the main channel from the channel is not changed, but the sub-channel only is changed as shown in FIG. 3(b). In FIG. 3(a), the channel being currently received (selected), together with the image, is OSD displayed on the upper right side of the display. In this state, when the “-” key 33a is pressed by the user, the main channel is fixed (decided) as “4” previously selected, and the selection procedure is shifted to the sub-channel selection, that is, as shown in FIG. 3(b), the selection state is shifted to the sub-channel input waiting state. In this state, “main channel number-” and a cursor “_” for inputting the sub-channel are OSD displayed on the upper right side of the display. Therefore, the user operates the ten key 33a of the remote controller 30 while watching the display to input the sub-channel number and fix the number with the “Enter” key 38, whereby the channel is changed to a desired one. The channel number is inputted from the high-order digit, and inputting one number causes another number having been previously inputted to be shifted to the left and OSD displayed (see FIGS. 7(a) and 7(b)).

In this way, it is sufficient for the user to input the subchannel number following the “-” key 33a, thereby allowing the input operation of the main channel to be omitted and the channel change to be easily performed. Operation of the “-” key 33a having the same form as a character “-” showing the relationship between the main channel number and the sub-channel number in the ATSC standard causes the input of the main channel number to be omitted as described above, and the display to be shifted to the sub-channel input waiting display, so that the user can intuitively operate the channel change. When the main channel is changed and the sub-channel is inputted, they are OSD displayed as shown in FIG. 3, so that the user can easily and visually understand the hierarchical structure, thereby making it easy to distinguish the main channel number from the sub-channel number, and preventing the confusion between the main channel and the sub-channel when the channel number is inputted.

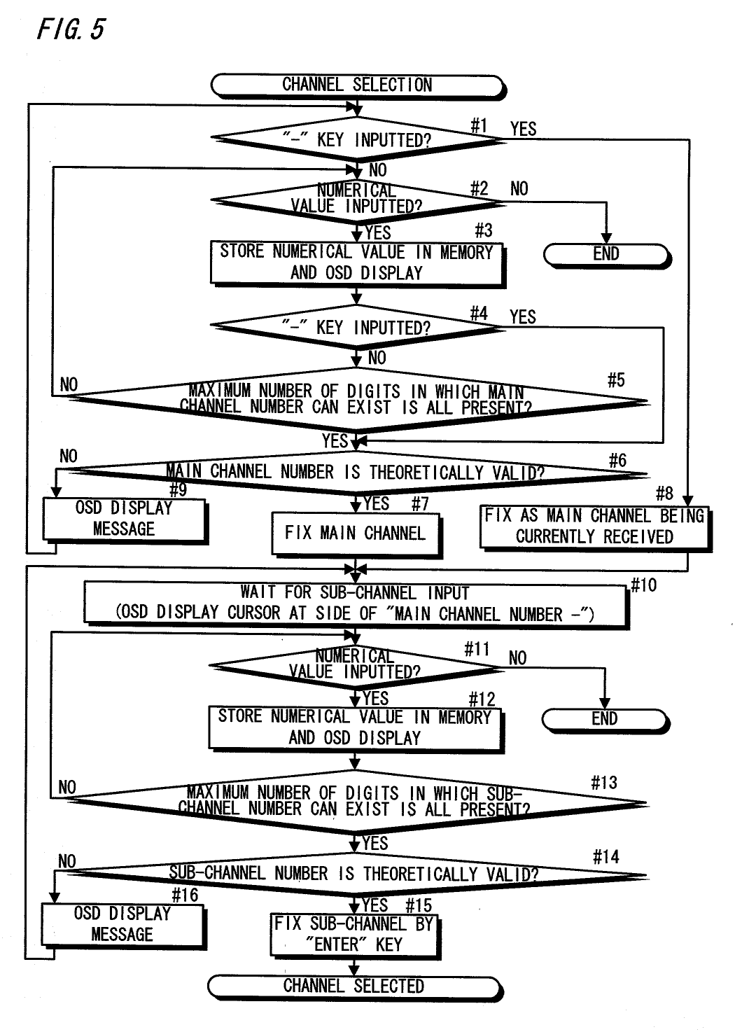

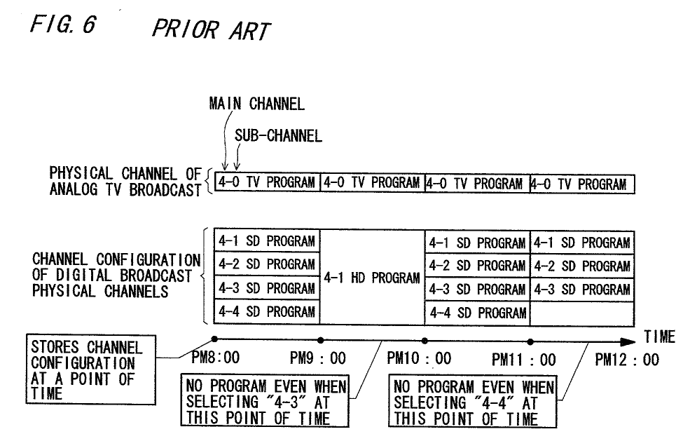

The operation of another channel change by using the ten keys 33 of the remote controller 30 and the display at that time will be shown in FIG. 4 and explained. In this example, the selection of “8” channel for the main channel is shown, in which at first inputting “8” from the ten keys 33 by the user causes “8” and a cursol for inputting the following numeric character to be OSD displayed on the upper right side of the display as shown in FIG. 4(a). Further inputting the “-”, key 33a from the display causes the main channel to be fixed as “8”, and a cursor “-” for inputting the sub-channel as “8-” to be OSD displayed as shown in FIG. 4(b). In this way, the main channel selection which requires three steps in the conventional device shown in FIG. 7 can be simplified such that it requires two steps by utilizing the “-” key. The input procedure of the sub-channel thereafter is similar to the example shown in FIG. 3, so that the explanation will be omitted.

With reference to FIG. 5, the operation by the control unit 8 of the receiver 1 when a channel change instruction is inputted by the operation of the ten keys 33 of the remote controller 30 from the user will be explained hereinafter. At first, during period when broadcasting signals are received and the image is displayed on the display device 12, the “-” key 33a is inputted (YES at#1), the control unit 8 fixes the channel as the main channel being currently received (#8), and waits for the sub-channel input (#10).

When the “-” key 33a is not inputted (NO at #1), and a numerical value is inputted from the ten keys 33 (YES at #2), the control unit 8 makes the memory 7 to store the inputted numerical value, and the display device 12 to OSD display it (#3). Further, when the “-” key 33a is not inputted (NO at #4), the control unit 8 reads the inputted numerical value from the memory 7, decides whether the maximum number of digits in which the channel number can exist is all present, and when being all present (YES at #5), decides whether the main channel number is theoretically valid (#6). The decision at #6 is made according to whether the inputted main channel number is present in the channel information made stored in the memory 7. For example, when “999” is inputted as the main channel number, currently such main channel is not present, so that the main channel can be decided to be theoretically invalid. When the main channel is theoretically valid (YES at #6), the control unit 8 fixes the main channel number (#7), and waits for the sub-channel input (#10). When the maximum number of digits of the main channel number is not all present (NO at #5), the operation returns to #2, and repeats #2 through #5. When the main channel number is theoretically invalid (NO at #6), the control unit 8 displays a predetermined message (#9), and returns to #1 where it inputs again the main channel number.

During period when waiting for the sub-channel, a cursol is OSD displayed on the side of “main channel number-” (#10), and when a numerical value is inputted (YES at #11), the inputted numerical value is stored in the memory 7, and displayed on the display device 12 (#12). Further, the control unit 8 reads the inputted numerical value from the memory 7, decides whether the maximum number of digits in which the sub-channel number can exist is all present, and when being all present (YES at #13), decides whether the sub-channel number is theoretically valid (#14). The decision is made in similar manner to #6 on the validity of the main channel number, and when being valid (YES at #14), receiving the “Enter” causes the sub-channel to be fixed (#15) to execute the channel selection. When the maximum number of digits of the main channel number is not all present (NO at #13), the operation returns to #2, and repeats #2 through #5. When the sub-channel number is theoretically invalid (NO at #14), the control unit 8 displays a predetermined message (#16), and returns to #10 where it inputs again the sub-channel number. When a numerical value is not inputted at #2 or #11 (NO at #2 or #11), the process is to be ended.

The invention is not limited to this embodiment but applicable to many variants; for example, the digit number of main/sub-channel is not limited to three-digit/two-digit but may be composed of bigger number digit. According to the present invention, regardless the digit number of these channel numbers, input steps necessary on inputting smaller channel numbers such as one-digit or two-digit remain same, thus it enables to always select a channel by the minimum input steps.

The predetermined operation key is not limited to the “-” key, and may be a key to which a character display showing the relationship between the main/sub-channel is applied corresponding to the operation of the digital broadcasting. Further, the channel number inputted and fixed by the ten keys 33 is not only OSD displayed on the display device 12, but also may be made displayed on a display device such as LCD (Liquid Crystal Display) separately provided on the exterior of the receiver 1 or the remote controller 30. Still further, the receiver 1 may be configured to be contained in the body of a television receiver or a video recorder.

What is claimed is:

1. A channel selection device in the digital/analog broadcasting receiver comprising, a receiver for receiving coded digital/analog broadcasting signals transmitted from a broadcasting station, a digital/analog decoder for decoding the digital/analog broadcasting signals received by the receiver and outputting them to an image-displaying display device connected to the broadcasting receiver, a memory for storing a channel information included in the broadcasting signals decoded by the digital decoder, a control unit for controlling the device, and an input device used for a user to input an operation instruction including the channel selection to the control unit, wherein the digital broadcasting signals have one or a plurality of sub-channels to transmit contents in one main channel; characterized in that,
the input device has a predetermined operation key to which an operation instruction is assigned to fix the channel, in addition to numerical-value input keys for inputting the channel number;
the control unit fixes the main/sub-channel selected by the following first or second selecting procedure in response to the operation instruction from the input device during the reception of the broadcast by the broadcasting receiver;
the first selecting procedure, when receiving an instruction by the predetermined operation key without inputting the main channel number by the numerical-value input keys, fixes the main channel being currently received, and waits for the sub-channel number input, and then fixes the sub-channel of the number of the numerical value inputted by the numerical-value input keys; and
the second selecting procedure, when receiving the input of a numerical value by the numerical-value input keys, and then receiving the input by the predetermined operation key, fixes the main channel of the number of the inputted numerical-value, and waits for the sub-channel number input, and then fixes the sub-channel of the number of the numerical value inputted by the numerical-value input keys.

2. A channel selection device in the digital/analog broadcasting receiver comprising, a receiver for receiving coded digital/analog broadcasting signals transmitted from a broadcasting station, a digital/analog decoder for decoding the digital/analog broadcasting signals received by the receiver and outputting them to an image-displaying display device connected to the broadcasting receiver, a memory for storing a channel information included in the broadcasting signals decoded by the digital decoder, a control unit for controlling the device, and an input device used for a user to input an operation instruction including the channel selection to the control unit, wherein the digital broadcasting signals have one or a plurality of sub-channels to transmit contents in one main channel; characterized in that,
the input device has a predetermined operation key to which an operation instruction is assigned to fix the channel, in addition to numerical-value input keys for inputting the channel number; and
the control unit, when receiving an instruction by the predetermined operation key while the broadcasting receiver is receiving the broadcast, waits for the sub-channel number input.

3. The channel selection device in the digital/analog broadcasting receiver according to claim 2, wherein the control unit, when receiving an instruction by the predetermined operation key without inputting the main channel number by the numerical-value input keys while the broadcasting receiver is receiving the broadcast, fixes the main channel being currently received, and waits for the sub-channel number input, and then fixes the sub-channel of the number of the numerical value inputted by the numerical-value input keys.

4. The channel selection device in the digital/analog broadcasting receiver according to claim 2, wherein the predetermined operation key is a “-” key.

5. The channel selection device in the digital/analog broadcasting receiver according to claim 2, wherein the channel selection device further comprises an On-Screen Display (hereinafter described as OSD) output circuit for OSD displaying the main channel number and the sub-channel number inputted by the numerical-value input keys and fixed by the control unit on the display device.
